(19) United States
(12) Patent Application Publication
(10) Pub. No.: US 2022/0129761 A1
(43) Pub. Date: Apr. 28, 2022

(54) TUNING A NEURAL NETWORK LEARNT BY UNSUPERVISED LEARNING

(71) Applicant: Cortica Ltd., Tel Aviv (IL)

(72) Inventor: Karina Odinaev, Tel Aviv (IL)

(73) Assignee: Cortica Ltd., Tel Aviv (IL)

(21) Appl. No.: 17/447,052

(22) Filed: Sep. 7, 2021

Related U.S. Application Data
(60) Provisional application No. 63/075,089, filed on Sep. 4, 2020.

(51) Int. Cl. G06N 3/08

(52) U.S. Cl. CPC G06N 3/088

(57) ABSTRACT

There may be provided a neural network (NN) and a learning process. The learning process may include (a) feeding media units to the NN, (b) generating signatures by the NN—till obtaining many (for example, at least 1,000,000 signatures), and (c) performing an optimization (or a sub-optimal process) of distances between signatures—and assign weights that will lead to the optimal or sub-optimal distances.

### BACKGROUND

There is a growing need to improve neural networks.

### BRIEF DESCRIPTION OF THE DRAWINGS

FIGS. 1-3 illustrate examples of neural networks.

### DESCRIPTION OF EXAMPLE EMBODIMENTS

The specification and/or drawings may refer to an image. An image is an example of sensed information unit. Any reference to an image may be applied mutatis mutandis to a sensed information unit. The sensed information unit may be applied mutatis mutandis to a natural signal such as but not limited to signal generated by nature, signal representing human behavior, signal representing operations related to the stock market, a medical signal, and the like. The sensed information unit may be sensed by one or more sensors of at least one type—such as a visual light camera, or a sensor that may sense infrared, radar imagery, ultrasound, electro-optics, radiography, LIDAR (light detection and ranging), a non-image based sensor (accelerometers, speedometer, heat sensor, barometer) etc.

The sensed information unit may be sensed by one or more sensors of one or more types. The one or more sensors may belong to the same device or system—or may belong to different devices of systems.

The sensed information may be processed by a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

There may be provided a neural network (NN)—(being a convolution neural network (CNN) or another neural network (ANN) that may include a number of layers that are connected to each other.

The NN may be adapted (through training and the like) to a certain content—for example medical information, X-ray sensed information, camera sensed information, and the like.

The NN may be initially set with initial weights (for example by performing an initial learning process—for example without detailed supervised examples—for example provide x-ray images untagged.

It is desired that the NN will provide similar outputs (for example similar signatures) for similar medial units and provide—different signatures for different media units.

The initial learning process may be totally unsupervised—and may be aimed to order media units on a N dimension space (for example sphere, N being an integer that exceeds one)—for example more similar media units will be closer to each other in the N dimension space.

The NN may include many neurons—for example 10,000,000 neurons—with initial randomly assigned weights.

The learning process may include (a) feeding media units to the NN, (b) generating signatures by the NN—till obtaining many (for example at least 1,000,000 signatures), and (c) performing an optimization (or a sub-optimal process) of distances between signatures—and assign weights that will lead to the optimal or sub-optimal distances.

Yet another learning process may include a more supervised learning process—in which the media units are still untagged—but the learning process receives defined operators—that should be robust in advance—lighting, orientation—operations that are similar are close to each other.

The more supervised learning process may includes (a) feeding media units to the NN, (b) generating signatures by the NN—till obtaining many (for example at least 1,000,000 signatures), and (c) performing an optimization (or a sub-optimal process) of distances between signatures—and assign weights that will lead to the optimal or sub-optimal distances.

In any learning process—the robustness may be obtained by feeding the NN with a large array of media units—generate signatures by the NN, cluster the signatures to provide clusters (clustering may be without constraints or may be constrained—for example by number of signatures per cluster, by number of clusters, by defining cluster rules—how to determine that a signature belongs to the cluster, defining required differences between clusters, and the like). The clusters may eb further divided to sub-clusters. Metadata may be added to clusters and/or sub-clusters of any level.

There may be provided solution that may provide a NN that is (a) robust to small changes on a pixel level, and (b) robust to movements inside the signal (=translation invariant).

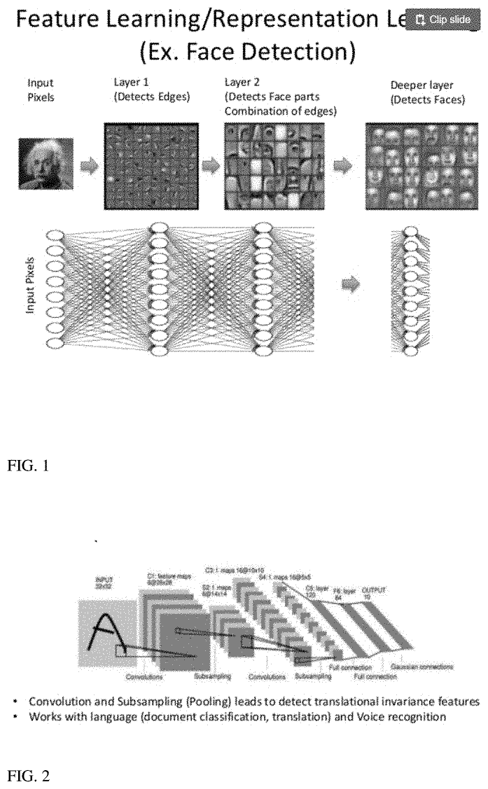

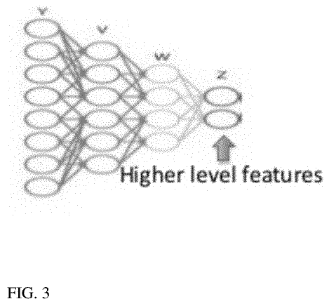

Item (a) may be achieved by providing a NN that (i) supports spatial dimension reduction (such as pooling, convolution, projection from high to low receptive fields), and may be built bottom up, from small and simple patterns to more and more complex. FIGS. 1 and 2 illustrate an example that fulfills item (a). FIG. 3 illustrates building a NN bottom up. Referring to FIG. 2—it illustrates max pooling. The idea of complex cell layer is to “pool” a set of simple cells and acquire the same data from those simple cells (e.g invariant translation, rotation invariant, etc). Basically, where small movements in a certain layer will be retranslated to the same output in the next layer. In FIG. 2—assuming that an input image has 10 by 10 pixels, and there is a one-pixel nose at coordinates (4,5) and one-pixel mouth at coordinates (6,5). The process may define a pattern that a mouth beneath a nose compose a face. Max-pooling maps the 10×10 picture to a 5×5 picture. Thus the nose at (4,5) is mapped to (2,3) and the mouth at (6,5) is mapped to (3,3) in the smaller picture. Now the process takes another picture with a one-pixel nose at (4,6) and one-pixel mouth at (6,6), i.e. a translation of one pixel to the right. By using Max-pooling, they are mapped to (2,3) and (3,3), which is still classified at a face. And this ability is called “translation invariance”. Actually, max-pooling not only creates translation invariance, but also—in a larger sense—deformation invariance.

Item (b) may be achieved by using a NN that is built on a repetitive manner (or scanning technique of patches, i.e. dividing the image into patches, and looking for the same patterns in every patch).

A NN that achieves (a) and (b) should undergo a weight optimization (or sub-optimal setting) process to achieve a predefined rule—for example maximal average distance between the signatures.

The NN may be generated by a FIRST method: (a) generate a NN with random weights, and preform an iterative process—until reaching a predefined rule: (b) feeding the NN with multiple media units, (c) generate signatures by the NN, (d) measure a distance between each pair of signatures, (e) calculate an average of distances, (f) change weights, (g) check whether predefined rule (PR) was reached—if not jump to (b). The predefined rule may be a maximal value of the average distance. Other predefined rules may be applied.

There may be provided a SECOND method that may start by applying the FIRST method to provide a NN that generates signatures that comply with the PR.

Once this is completed—perform the FIRST method on clusters and/or sub-clusters to obtain clusters that comply with the PR.:
Generate a NN—for example according to the FIRST method to provide a NN that as a whole complies with the PR.
Obtain images—for example obtain random images.
Using the NN to generate signatures of the images.
Clustering of the signatures. The clustering may stop when reaching a certain cluster size, respectively. A cluster may include one or more other clusters (may be referred to as sub-clusters)
For each cluster (or for at least some of the clusters)—apply the first METHOD, mutatis mutandis, on the cluster—for example change weights so that the distances between signatures that belong to the cluster comply with the PR.
Different clusters may be associated with different types of objects—and the FIRST method may be applied on multiple clusters of a certain type—to optimize the type of cluster to comply with the PR.

The outcome of the second method are clusters or cluster types that comply with the PR.

The FIRST method and/or the SECOND method may be applied on NN that are associated with different domains and comply with the PR- or to one or more predefined conditions.

These NN are preceded by a perception router/s that may sent any input to the relevant NN and/or to the relevant cluster.

It is appreciated that software components of the embodiments of the disclosure may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the disclosure. It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub combination. It will be appreciated by persons skilled in the art that the embodiments of the disclosure are not limited by what has been particularly shown and described hereinabove. Rather the scope of the embodiments of the disclosure is defined by the appended claims and equivalents thereof.

What is claimed is:

1. A method as substantially illustrated in the specification.

2. A non-transitory computer readable medium that stores instructions as substantially illustrated in the specification.

3. A system as substantially illustrated in the specification.
